(19) United States
(12) Patent Application Publication
(10) Pub. No.: US 2016/0006716 A1
(43) Pub. Date: Jan. 7, 2016

(54) SYSTEM AND METHOD FOR SECURE DIGITAL CONTENT DELIVERY

(71) Applicant: Barabajagal, LLC, Palm Springs, CA (US)

(72) Inventor: Jason P. Rothberg, Palm Springs, CA (US)

(73) Assignee: Barabajagal, LLC, Palm Springs, CA (US)

(21) Appl. No.: 14/634,625

(22) Filed: Feb. 27, 2015

Related U.S. Application Data
(60) Provisional application No. 62/019,721, filed on Jul. 1, 2014.

(51) Int. Cl. H04L 29/06; G06Q 20/40; H04L 29/08

(52) U.S. Cl. CPC H04L 63/083; H04L 67/32; G06Q 20/40

(57) ABSTRACT

A system for the secure delivery of digital content related to the purchase of a physical product is presented. A unique digital key and PIN is used to access digital content featuring the artist. The digital key leads to a custom opt-in page. After providing the PIN and user information at the opt-in page, the system directs the purchaser to a customized landing page where the purchaser may access a multitude of digital content such as social media feeds, digital images and videos, and streaming audio centered on the featured artist. A digital download to be saved by the user on any device is also available to the user. The system tracks the user's online interactions and delivers analytics back to the brand of the physical product and the digital content provider. The process prohibits theft, secures delivery of the digital content, and contributes detailed metrics on each transaction.

### CROSS-REFERENCE TO RELATED APPLICATIONS

This application claims priority to U.S. Provisional Patent Application No. 62/019,721 filed on Jul. 1, 2014. The patent application identified above is incorporated here by reference in its entirety to provide continuity of disclosure.

### FIELD OF THE INVENTION

The present disclosure relates to a secure distribution channel for digital content. In particular, the disclosure relates to a system that incentivizes the purchase of a physical product by pairing the purchase with the secure delivery of related digital content while providing purchaser metrics to the brand of the physical product and digital content providers.

### BACKGROUND OF THE INVENTION

In the beginning of digital music availability, because of free file-sharing programs such as Napster. BitTonent, and most recently Megaupload, record production companies feared the digital revolution as piracy was rampant and free/shared content was reaching undocumented consumers at alarming rates without compensation to the content providers. Sales of vinyl records, compact discs (CD), cassette tapes. VHS tapes, digital video discs (DVD), and books through typical brick and mortar stores suffered dramatically. For years, the music industry's decline looked terminal, with the record companies seemingly unable to come up with digital business models that could compete with the lure of online piracy.

Record companies were initially reluctant to embrace digital methods of distribution, seeing only the threat from online piracy. However, in recent years governments around the world are increasing efforts to address the piracy issue and are cracking down on illegal tile sharing. As a result, digital music sales, which accounts for about ⅓ of global music sales and more than half of U.S. music sales, has been growing. Downloads, subscriptions and ad-supported music sales available through services such as iTunes. Amazon, Pandora. and Spotify are all growing. A consumer of digital music has many options from which to purchase digital content.

Although the sale of digital music files is increasing. digital content providers would benefit from exposure to additional consumers, especially consumers that have been identified to show a preference for their particular product. It would be beneficial to the content providers to be able to identify opportunities for additional sales based on previous purchases of not only digital content but related physical products as well. An opportunity exists to offer consumers more than just the digital music files, but digital music files that are related to the purchase of a physical product such as it T-shirt.

The prior art offers online incentive based programs associated with physical products but none disclose pairing a secure digital download with the purchase of a related physical object.

For example, U.S. Pat. No. 7,424,617 to Boyd, et al. discloses an electronic points system that allows consumers to redeem online points that were earned offline for products from various participating companies. A selected bottle cap includes a notification that it is worth a number of points in the system. The consumer registers the cap with the system and banks the points that it is worth. The consumer can then choose from a number of participating companies to redeem the points for merchandise.

U.S. Patent Publication No. 2002/0169668 to Bank, et al. discloses a system of providing online promotions. A consumer purchases a product which includes an alphanumeric sequence along with an inter address. The consumer follows the internet address to the webpage of the purchased product. The consumer provides the alphanumeric number on the website to redeem a value such as an electronic coupon. The coupon can be used to shop online at participating stores.

U.S. Patent Publication No. 2002/0026357 to Millet; et al. discloses a system for targeting a promotion to a user based on a user-entered product identifier. The product identifier is associated with a particular product. Once the product identifier is received from a client device of the user, a promotional offer for the product is retrieved. Such promotional offers include rebates, sale offers, and discount offers. The promotional offer is stored on the system and the user can access the offer on the system with a secure user account requiring a login d password.

SUMMARY OF INVENTION

Accordingly, an embodiment of the system pairs a physical product with “value added” digital content. A user is connected to a system server via the Internet. The system server is connected to a database that stores user account information and licensed digital content.

A unique digital key and PIN received on a tag with the purchase of the physical product of a featured artist is used to access digital content featuring the artist. Following the digital key via the Internet takes the purchaser to a customized opt-in page displaying images related to the physical product. After providing the PIN and identifying user information via email, SMS, Facebook™, or Twitter™, the system directs the purchaser to a customized landing page where the purchaser may access a multitude of digital content such as social media feeds, digital images and videos, and streaming audio centered on the featured artist. The purchaser may access the landing page as often as desired. The purchaser may also download digital content to an audio or video playing device. In one embodiment, the digital download is only available for download once and them becomes inactive. The system tracks the purchaser's activity on the landing page and provides analytics related to sales and use of the physical product and the digital content. The system associates the unique digital key and PIN combination with the purchaser and the physical product. The system prohibits theft of digital content and contributes detailed metrics on each transaction. Original purchases, activity on the landing page, and any additional purchases associated with the user account accumulate credits. Credits can be redeemed for additional merchandise.

Those skilled in the art will appreciate the above-mentioned features and advantages of the invention together with other important aspects upon reading the detailed description that follows in conjunction with the drawings provided.

### BRIEF DESCRIPTION OF THE DRAWINGS

In the detailed description of the preferred embodiments presented below, reference is made to the accompanying drawings.

FIG. 1 is schematic of the system components.

FIG. 2 is a schematic of the database.

FIG. 3 is a flow chart of system steps.

FIG. 4 is a schematic of an opt-in page.

FIG. 5 is a schematic of a landing page.

FIG. 6 is a schematic of a music web application.

FIG. 7 is a schematic of a gallery web application.

FIG. 8 is a schematic of a videos web application.

FIG. 9 is a schematic of a social media web application.

FIG. 10 is a schematic of a charity web application.

FIG. 11 is a schematic of a product store web application.

FIG. 12A is a plan view of the front of a hangtag with a QR code.

FIG. 12B is a plan view of the back of a hangtag with a OR code.

FIG. 13 is a plan view of a physical product with a proximity tag.

FIGS. 14A and 14B is a copy of the source code for database structure.

FIG. 14C and 14D is a copy of the source code for verifying a user's access to digital content.

FIG. 14E is a copy of the source code for verifying access to a landing page.

FIG. 14F is a copy of the HTML for web applications on the landing page.

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code embodied thereon.

Any combination of one or more computer readable media nay be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium May include a propagated data signal with computer readable program code embodied therein, for example, in baseband or as part of a carrier wave. The propagated data signal may take any of a variety of forms, including, but not limited to, electro-magnetic, optical, or any suitable combination of them. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present disclosure may be written in any combination of one or more programming languages, including an object oriented programming language such as Java, C++, C#, .NET, Objective C, Ruby, Python SQL, of other modem and commercially available programming languages.

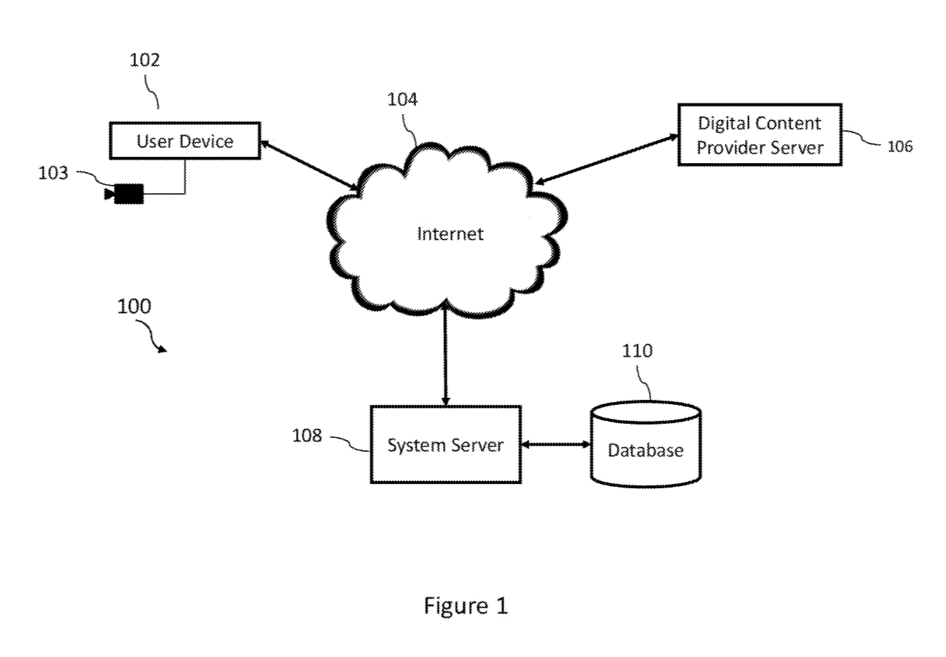

Referring to FIG. 1, the system comprises user device 102 connected to system server 108 via the Internet 104. User device 102 may be any Internet enabled device such as a smartphone, tablet, or personal computer. User device 102 should include an Internet browser such as Safari by Apple Inc., a scanning application such as OR Scanner by ShopSavvy, Inc., or include near field communication capability such as the iPhone 6 by Apple Inc. Smartphones such as the Apple iPhone tablets such as the Apple iPad, and personal computers such as the Apple MacBook will suffice. It is envisioned that other smartphones, tablets, and personal computers from other manufactures will also suffice. Camera 103 is connected to user device 102. In a preferred embodiment, the camera is integrated with a hand-held user device such as a smartphone. Digital content provider server 106 is connected to system server 108 via the Internet. Examples of digital content providers are motion picture companies, music recording companies, and publishers. System server 108 is connected to database 110. The digital content provided by digital content provider server 106 is stored in database 110 and is subject to pre-negotiated licenses.

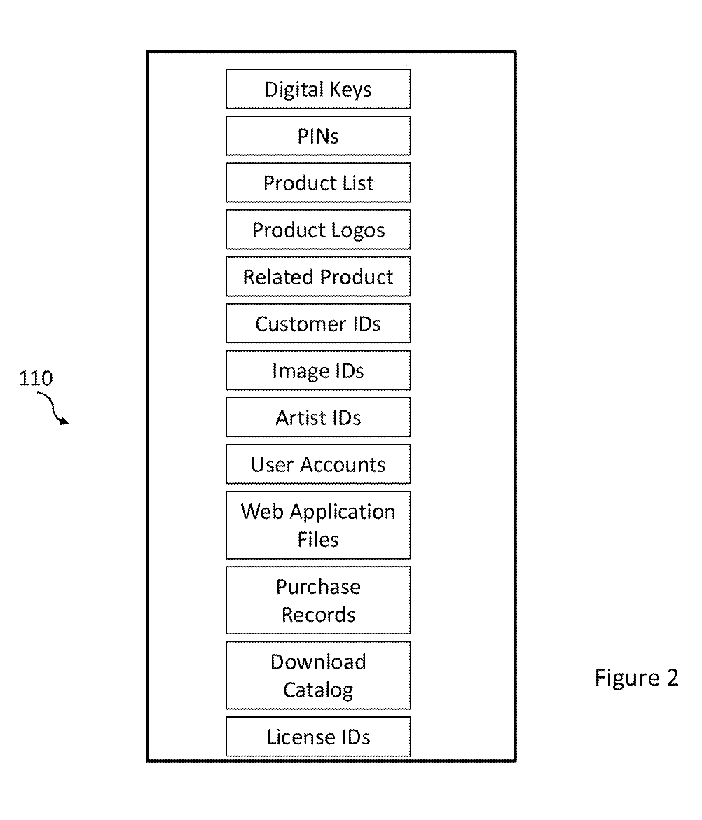

As shown in FIG. 2, database 110 has defined fields including but not limited to Digital Keys, PINs, Product List, Product Logos, Related Products, Customer IDs, Image IDs, Artist Ins, User Accounts, Web Application Files, Purchase Records, Download Catalog, and License IDs.

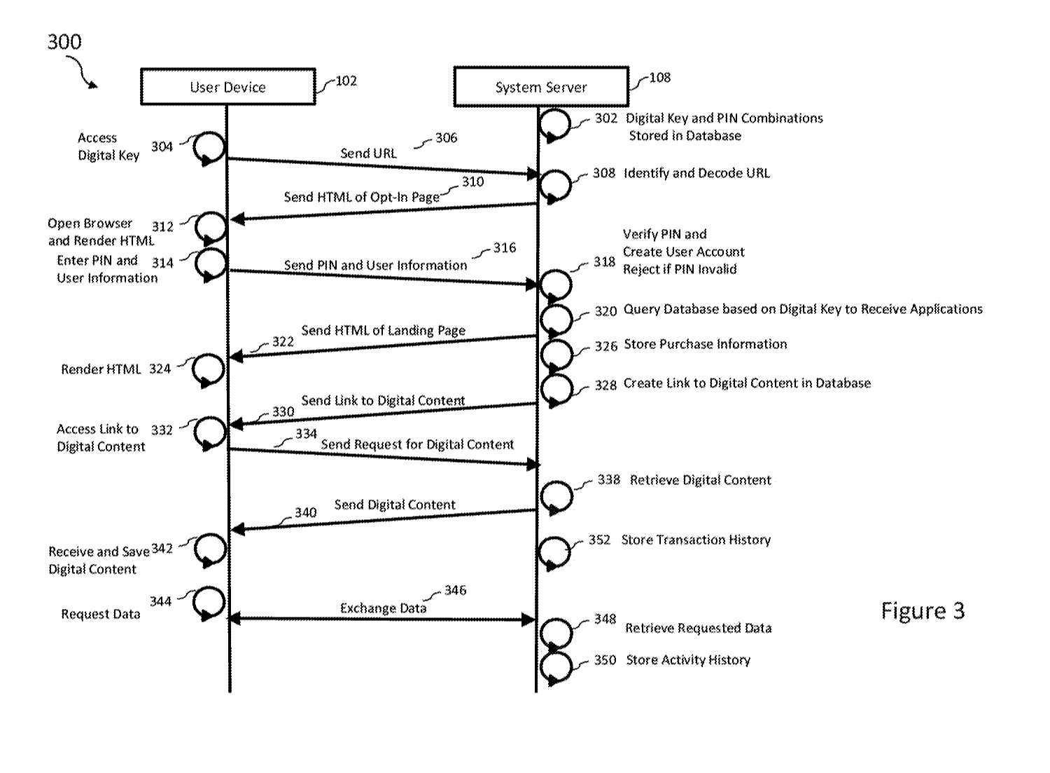

FIG. 3 shows the steps 300 of the system server interacting with user device 102 in a preferred embodiment. At step 302, a unique digital key and PIN combination for each physical product is stored in the database. The digital key and PIN are a unique combination linked to specific digital content related to the purchased product. In a preferred embodiment, the physical product is an article of clothing, such as a designer T-shirt. and the digital content is access to music, movies, books, images, and videos. For description purposes of this application going forward, the physical product purchased is an Elton John designer T-shirt featuring album art of Elton John's album, The Diving Board and the digital content is streaming music from The Diving Board album; pictures and videos of Elton John and a one-time downloadable copy of The Diving Board by Elton John in .mp3 digital format. It is understood that other physical products such as CD and vinyl cases, video games and toy packaging, hats, cups, jewelry, banners, pins, towels, etc. Which can be naturally associated with music, movies, or literature can be the physical product purchased containing the digital key and PIN.

At step 304, the user device accesses the digital key. The digital key in one preferred embodiment is a Quick Response (QR) code printed on a tag, the physical product itself, or a receipt of purchase. In other embodiments, a picture of the physical product itself can provide access to the digital key after being recognized as authenticated merchandise by the system server. The user device scans the QR code and is immediately directed to the opt-in page. As an additional marketing visual, the tag may be attached to the physical product via a lanyard, where the tag is shaped to resemble a VIP access pass or concert ticket similar to those received at concerts. In addition to QR codes, the digital key may be in other forms including a Uniform Resource Locater (URL) address, Near Field Communication (NFC) tags, or Radio Frequency Identification (RFID) tags. User device 102 decodes the digital key as a URL address such as http://musicalts.astrellainc.com/thedivingboard/info. The URL includes a code which uniquely identifies each physical product.

At step 306, user device 102 sends the URL address to the system server from the digital key.

At step 308, the system server identifies and decodes the URL address. The system server creates opt-in page HTML code to display a customized opt-in page. The opt-in page is customized with album art and manufacturer information related to the physical product. At step 310, the system server sends the opt-in page HTML code to user device 102.

At step 312, the user device opens an Internet browser and renders the opt-in page HTML code sent by the system server

At step 314, the PIN and user information is entered on the opt-in page. The user inputs the PIN received with the digital key and provides identifying information to set up a profile with the system. The PIN may be accessed under a scratch-off section of a tag or label attached to the physical product. The PIN may also be printed on the sales receipt or sent to the user through an email, text message or phone call. To access the digital content associated with the purchase of the physical product. the system requires the user to “opt-in” by supplying minimal profile information along with the PIN. The user may supply a mobile phone number, an email address, or the user may log in with previously established social media accounts. The digital providers and the brand of the purchased physical product can use the information provided for up-selling and re-marketing opportunities such as additional merchandise, event feeds with RSVP and ticketing options, and special event promotions with the user and their network of friends. Additionally, once the user “opts-in”, a message including a first link to a digital content download and a second link to the opt-in page is sent to the user via the medium the user used to initially log in. For example, if the user used an email at the opt-in page, an email with the links to the download and to the opt-in page will be sent to the user. The link to the opt-in page allows the user to revisit the opt-in page in the future without the digital key. Additionally, the opt-in page may be “bookmarked” in the browser of an Internet enabled device for future use without the need for the digital key. After “opting-in” from the opt-in page, the user device is automatically directed to the landing page for the particular digital content linked to the physical product purchase.

At step 316 the user device sends the entered PIN and user information to the system server.

At step 318, the system server verifies the PIN and digital key combination as valid with the database and creates a user account. If the submitted PIN and digital key combination is invalid, the user account is not created and the PIN is rejected.

At step 320 the system server queries the database for content coded to the PIN and digital key combination received from the user device. The system server creates landing page HTML code to display a customized landing page. The landing page is customized with album art and manufacturer information related to the physical product. Additionally the landing page includes web applications related to the physical product. At step 322, the system server sends the landing page HTML code to user device 102.

At step 324, the user device renders the landing page HTML code sent by the system server in an Internet browser an opens the customized landing page.

At step 326 the system server stores the purchase information in the database. Information stored includes an identification of the physical product purchased, HTML information, date, time, price, manufacturer, and point of purchase location.

At step 328, the server creates a link to downloadable digital content in the database. The link is in the form of a URL address such as http://musicalts.astrellainc.com/download?emailaddress=name@yahoo.com&token=247bf739-a286-42af-a42f-ec0baeec7427&band=thedivingboard.

At step 330, the system server sends a message to user with the link to the downloadable digital content. The message is sent to the user via the medium the user u initially log in. For example, if the user used an email at the opt-in page, an email with the link to the downloadable digital content will be sent to the user.

At step 332, the user clicks on the link to the downloadable digital content found in the message from step 330. At step 334, the user device sends the digital download request to the system server. At step 338, the system server retrieves the digital content from the database. The downloadable digital content is media files, such as .mp3 music files, saved locally to a user's device. The downloaded digital content may, in one embodiment, be free from any digital rights management (DRM) copy protections thus the user may share the downloaded content between any of the user's devices. The link can be limited to be valid for a one-tune download. In a preferred embodiment, the link will expire thirty (30) days after its creation. In this step, the digital key and the information that it contains related physically to the product is transformed into a different state or thing, lamely the chosen music or other digital content.

At step 340, the system server sends the digital content to the user's Internet enabled device. At step 342, the user device receives the download of the digital content which the user can save to a desired location on a desired device.

At step 352, the transaction history is stored by the system server. The history stored includes the digital content downloaded and the user information.

At step 344, the user interacts with the landing page. The landing page includes various web applications customized to the subject of the physical product purchase. For example. if the user purchased a designer T-shirt featuring the album art of a particular recording artist, the landing page will include web applications to: stream the music tracks from that album, view images and videos of the artist, view and interact with the social media streams of the artist, and view and research charities the artist supports. Au additional web application on the landing page provides viewing of and the ability to purchase other products similar to the designer T-shirt first purchased. At step 346, the user device and the system server exchange data based on the user's interaction with the web applications on the landing page. At step 348, the system server retrieves the requested information pursuant to the user's interaction with the web applications on the landing page.

All interactions such as streaming audio and video content, viewing still images, viewing a social media feed and favorite charities of, for example Elton John, and accessing the online store of the brand of the physical purchase, for example the designer T-shirt, are performed from the landing page through the web applications. The user may visit the landing page an unlimited number of times by following the link to the opt-in page received in the message received after “opting-in” and providing the PIN and user information again.

At step 334, the system server stores all user activity. The collected user activity information can be used by the physical product provider and the digital content provider to for re-marketing opportunities, to expand sales, and to build a consumer relationship beyond the initial purchase.

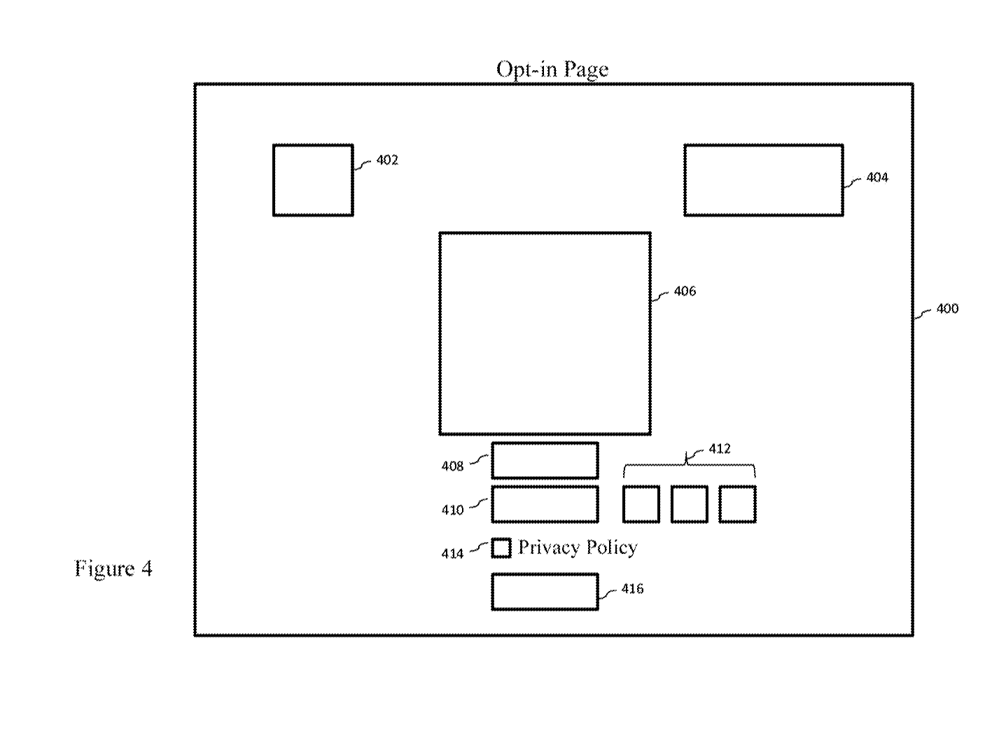

Referring to FIG. 4, the layout of opt-in page 400 is shown. Opt-in page 400 is displayed on the user device after the user device follows a digital key included with the purchase of a physical product, in the ongoing example, a designer T-shirt depicting album art of a musical artist. Server 108 recognizes the digital key and customizes opt-in page 400 with images related to the physical product. Opt-in page 400 includes product logo 402. For example, product logo 402 is the logo of the manufacturer of the designer T-shirt. Product logo 402 is an active link to the website of the T-shirt manufacturer. Product slogan 404 displays a marketing. slogan of the T-shirt. Album art 406 displays the album cover of the artist depicted on the T-shirt. Data entry box 408 is for input of the PIN associated with the purchased T-shirt. Data entry box 410 is for input of user information such as an email address or mobile phone number to create a user profile account with the system. Alternately, the user may provide user information through one of the social media links such as Twitter™, Facebook™, and Instagram™ provided at 412. Click box 414 is for the user to indicate that the user has read the privacy policy associated with the system. Click box 414 is either populated or its not. The “privacy policy” characters are linked to a page displaying the actual privacy policy for perusal by the user. Button 416 is the “Enter” button for submitting the data entered in data entry boxes 408, 410, 412 and 414.

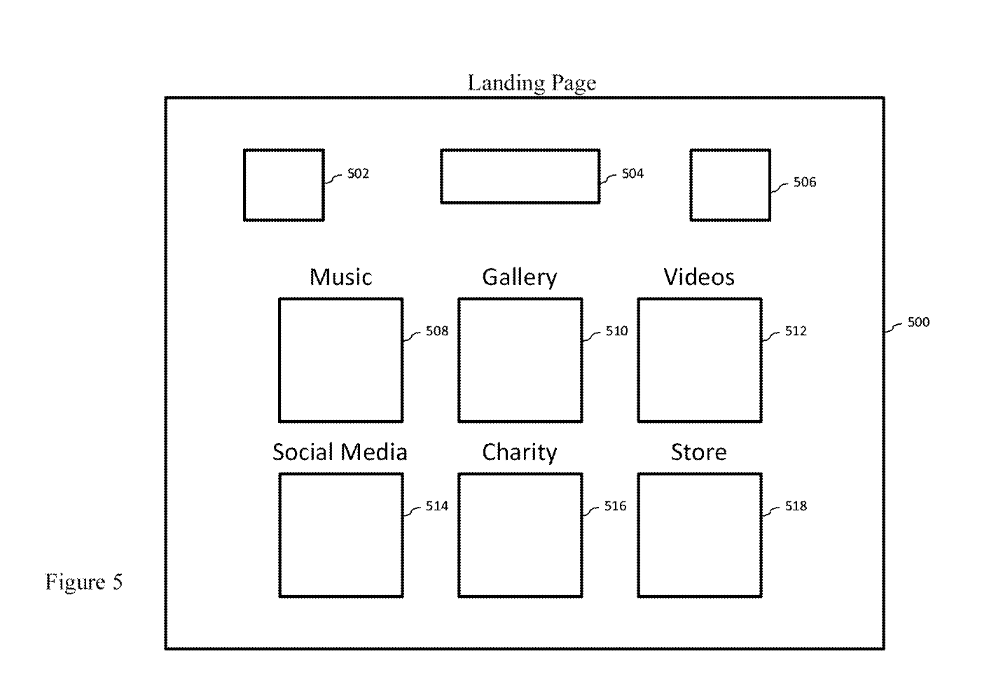

Referring to FIG. 5, the layout of landing page 500 is shown. Landing page 500 is displayed on the user device after creating a user profile and providing the PIN on the opt-in page. Server 108 recognizes the digital key and PIN combination and customizes landing page 500 by adding images and web applications related to the physical product. Album art 502 displays the album cover of the artist depicted on the T-shirt. Product slogan 504 displays a marketing slogan of the T-shirt. Product logo 506 is an active link to the website of the T-shirt manufacturer. Several web applications are displayed on the landing page. Through the user device, the user can interact with the web applications. Button 508 opens the “Music” web application. Button 510 initiates the “Gallery” web application. Button 512 activates the “Video” web application. Button 514 starts the “Social Media” web application. Button 516 activates the “Charity” web application. Button 518 opens the “Product Store” web application. All activity on the landing page especially purchases made via the “Product Store” web application are tracked and stored. Users are targeted with special purchasing offers and incentives based on their views and purchases of related content. In an alternate preferred embodiment, credits are earned through user activity and purchases. Additionally, completing various tasks through the web applications also earn credits. Tasks such as posting a picture of the user with the product on a particular social media feed or referring friends to create accounts and make purchases can earn credits. The credit value of each task is based on difficulty and effort required to complete the task. Users can use the earned credits to unlock previously inaccessible digital content of apply the credits towards additional purchases.

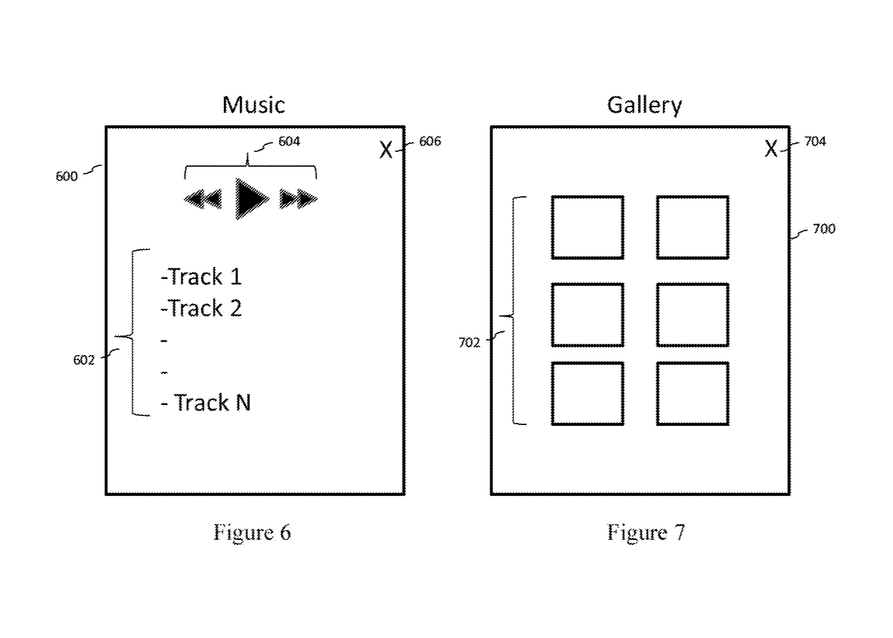

Referring to FIG. 6, the layout of music web application 600 is shown.

When music web application 600 is activated from the landing page, music from the featured album can be played through the user's Internet enabled device. For example. purchasing an. Elton John, The Diving Board designer T-shirt will provide, the ability to stream the music from the album through the user's Internet enabled device via music web application 600. Track listing 602 lists each track title in the order they appear on the album. Buttons 604 control which track is to be played. Buttons 604 provide previous track, play/pause, and next track functionality. Each individual track title can be played by directly clicking on the track title or by advancing or retreating through track listing 602 with the use of buttons 604. Clicking on any other web application on the landing page while music is playing from music web application 600 opens the other web application while the streaming music from music web application 600 continues to play. Close button 606 stops music web application 600 and returns the user to the landing page as shown in FIG. 5.

Referring to FIG. 7, the layout of gallery web application 700 is shown. When gallery web application 700 is opened from the landing page, thumbnails of still images. are presented to the user. Each thumbnail of thumbnails 702 represents a different image. Each image is related to the artist featured on the album art and the T-shirt. Close button 704 closes gallery web application 700 and returns the user to the landing page as shown in FIG. 5. Images viewed with gallery web application 700 can be saved locally by the user on the user's Internet enabled device.

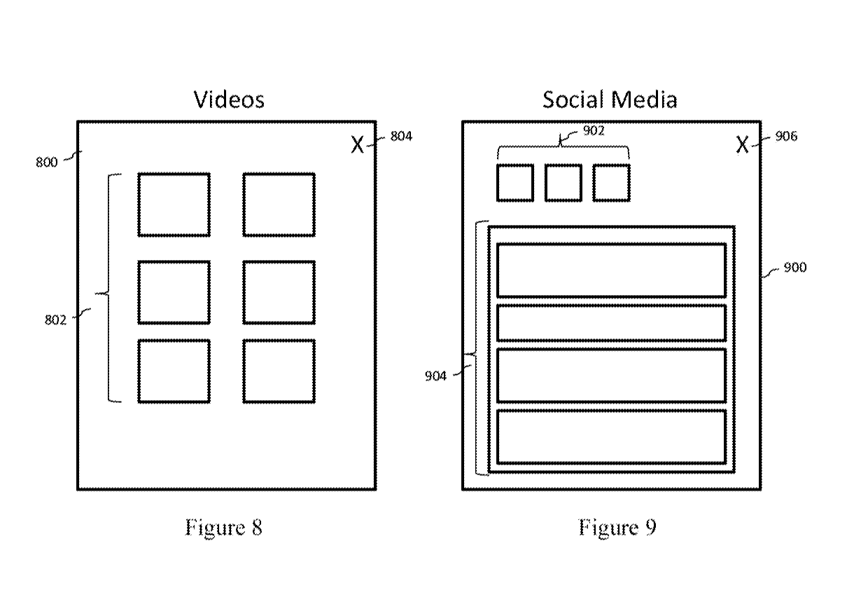

Referring to FIG. 8, the layout of videos web application 800 is shown. When video web application 800 is opened from the landing page, thumbnails of videos are presented to the user. Each thumbnail of thumbnails 802 represents a different video. Each video is related to the artist featured on the album art and the T-shirt. Close button 804 closes video web application 800 and returns the user to the landing page as shown in FIG. 5. Videos watched with videos web application 800 can be saved locally by the user on the user's Internet enabled device.

Referring to FIG. 9, the layout of social media web application 900 is shown. Buttons 902 are used to select which popular social media feed such as Twitter™, Facebook™, and Instagram™ the user would like to interact with. Once a social media link is chosen. messages 904 list the most recent entries to the chosen social media account of the featured album and artist. The system server queries the database for the application programming interface (API) to call the routine which loads the operations and functionalities of the chosen social media feed. The user may choose to post messages to the artist's social media outlets. Close button 906 closes social media web application 900 and returns the user to the landing page as shown in FIG. 5.

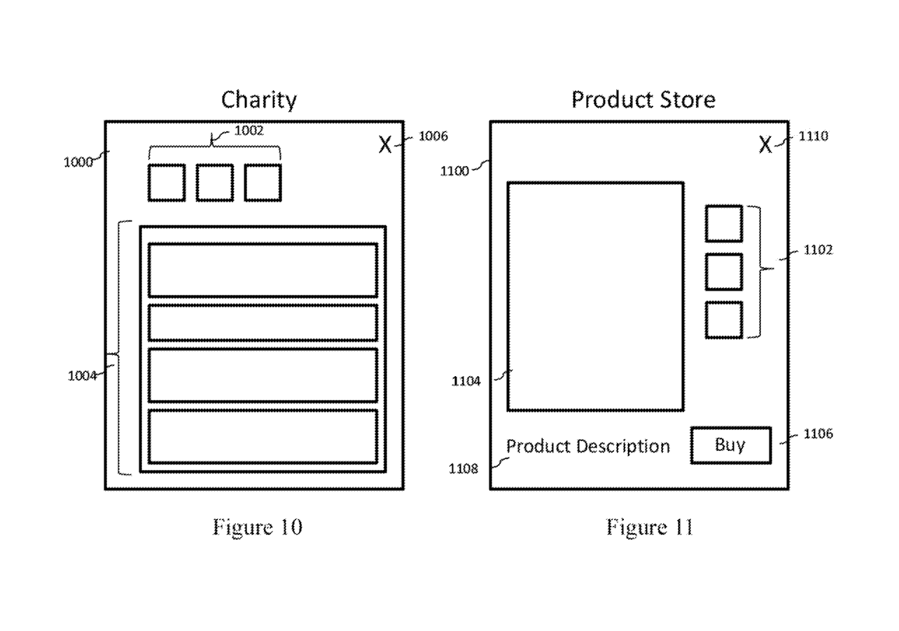

Referring to FIG. 10, the layout of charity web application 1000 is shown. Buttons 1002 are active links to the charities supported by the artist. Each button takes the user to the webpage of the chosen charity. Messages 1004 indicate comments from other users regarding the chosen charity. Messages 1004 are listed in chronological order. The user may choose to post messages to messages 1004. The system server queries the database for the application programming interface (API) to call the routine which loads the messages from the chosen charity website. Close button 1006 closes charity web application 1000 and returns the user to the landing page as shown in FIG. 5.

Referring to FIG. 11, product store web application 1100 is shown. Product store web application 1100 promotes other products by the manufacturer of the initial physical product purchased. Buttons 1102 display items for sale. The items for sale are related to the artist and the initial product purchased. Clicking on one of the button's of buttons 1102 features that item in display 1104. Display 1104 is active and allows the selected item to be viewed from different points of view. Buy button 1106 takes the user to the website of the manufacturer of the selected item and deposits the item in a virtual shopping cart as known in the art. Text 1108 is the product description Of the selected item. Close button 1110 closes product store Web application 1100 and returns the user to the landing page as shown in FIG. 5.

Referring to FIG. 12A and 12B, hangtag 1200 is shown. Hangtag 1200 includes slot 1202. Slot 1202 is used to attach hangtag 1200 to the physical product with a strap or lanyard. Hangtag 1200 is shaped to resemble a VIP access pass or ticket stub similar to those received at concerts. Other shapes would also suffice. The front of hangtag 1200, shown in FIG. 12A, includes album art 1204 and artist/album text 1206. The backside of hangtag 1200, shown in FIG. 12B, includes product logo 1208, product slogan 1210, OR code 1212, and PIN 1214. Each pair of OR code 1212 plus PIN 1214 on every individual hangtag 1200 is unique to the particular physical product hangtag 1200 is attached to. As previously discussed, scanning OR code 1212 with the user's Internet enabled device directs the user to the opt-in page. On the opt-in page the user enters PIN 1214 to reach the landing page customized to the particular physical product hangtag 1200 was attached to. On hangtag 1200, PIN 1214 is obscured from casual observance by a scratch-off substance that is easily removed after purchase of the physical. product.

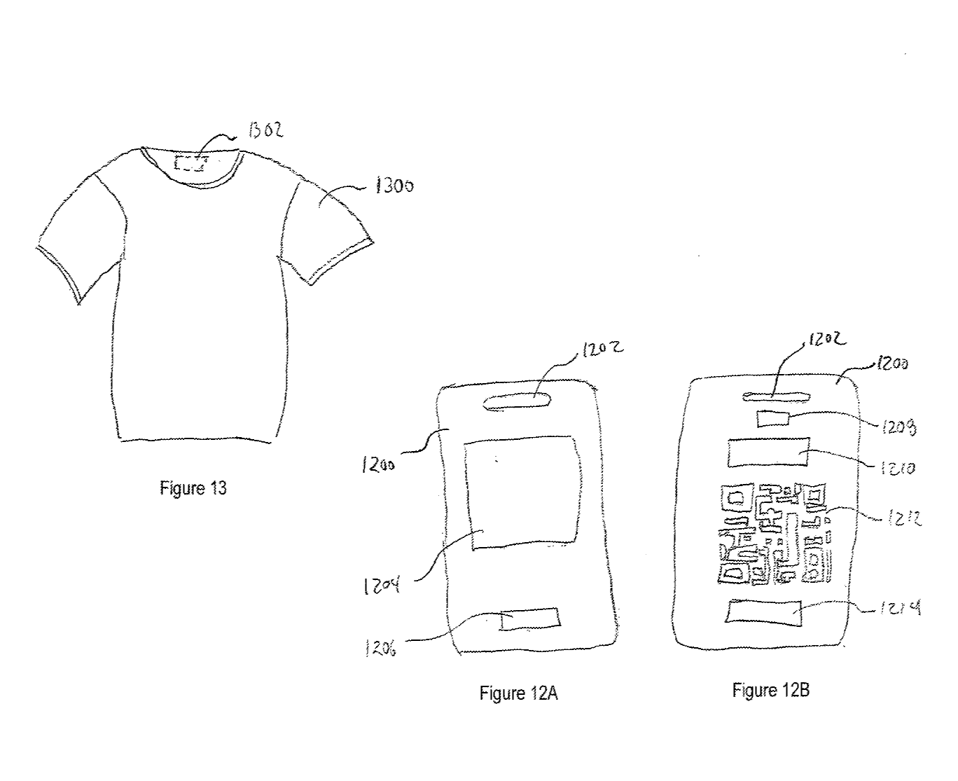

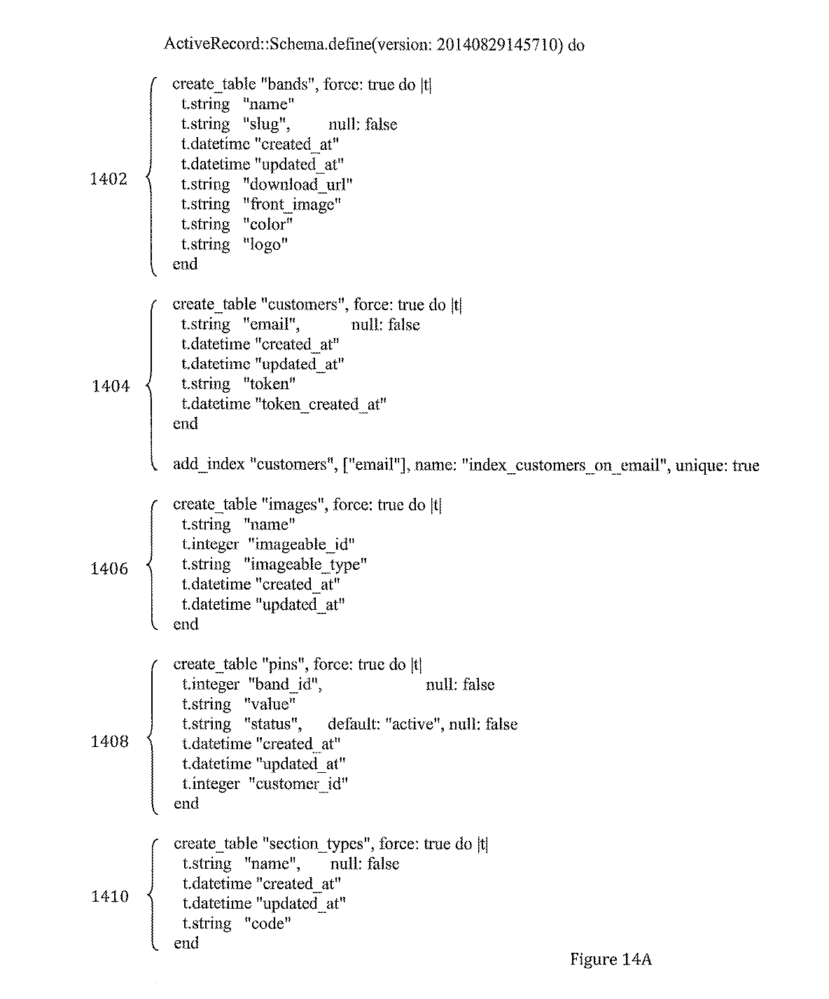

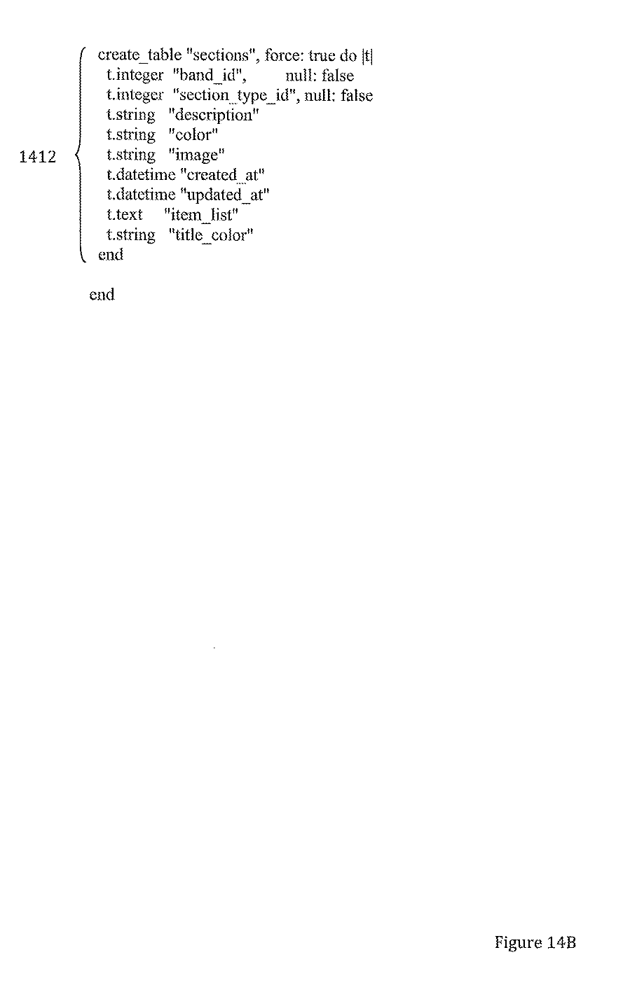

Referring to FIG. 13, physical product 1300 is shown. Physical product 1300 is depicted as a T-shirt. In an alternate preferred embodiment, physical product 1300 includes proximity tag 1302 such as a near field communication (NFC) tag or a radio frequency identification (RFID) tag rigidly affixed to it. Proximity tag 1302 provides a digital key ^{.}when located proximate a proximity tag reader of an Internet enabled device carried by the riser. Proximity tag 1302 directs the Internet enabled device of the user to the opt-in page.

In an alternate preferred embodiment, neither a QR code nor a proximity tag is present. A URL printed on the sales receipt of the physical product directs the user to the opt-in page. In this embodiment, the sales receipt further includes the PIN.

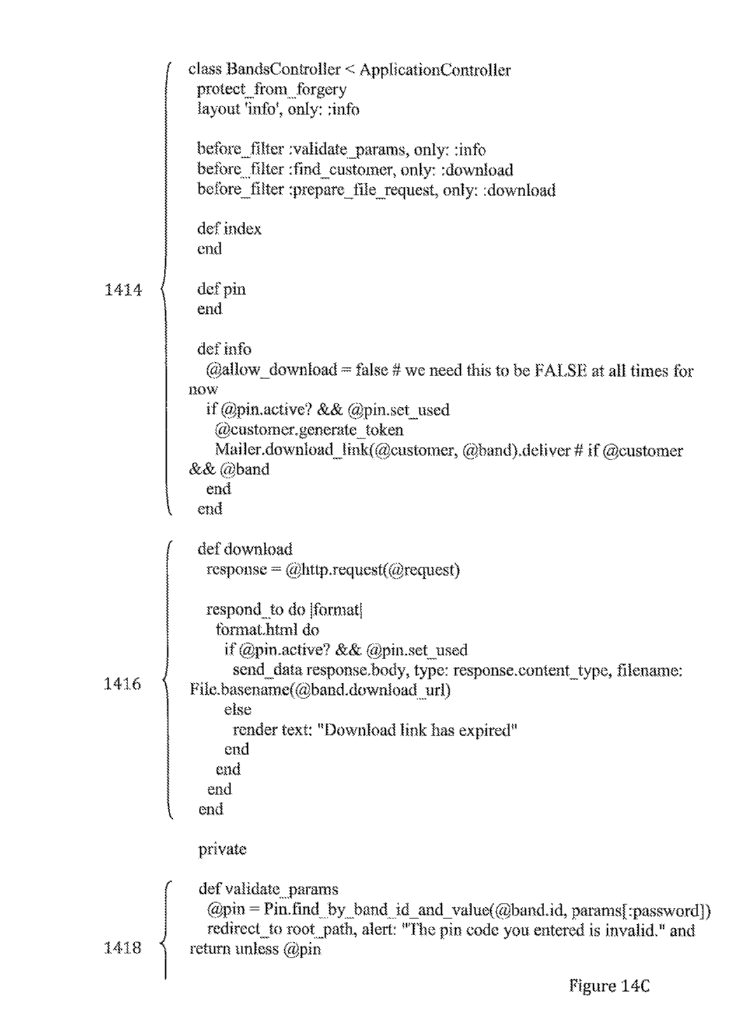

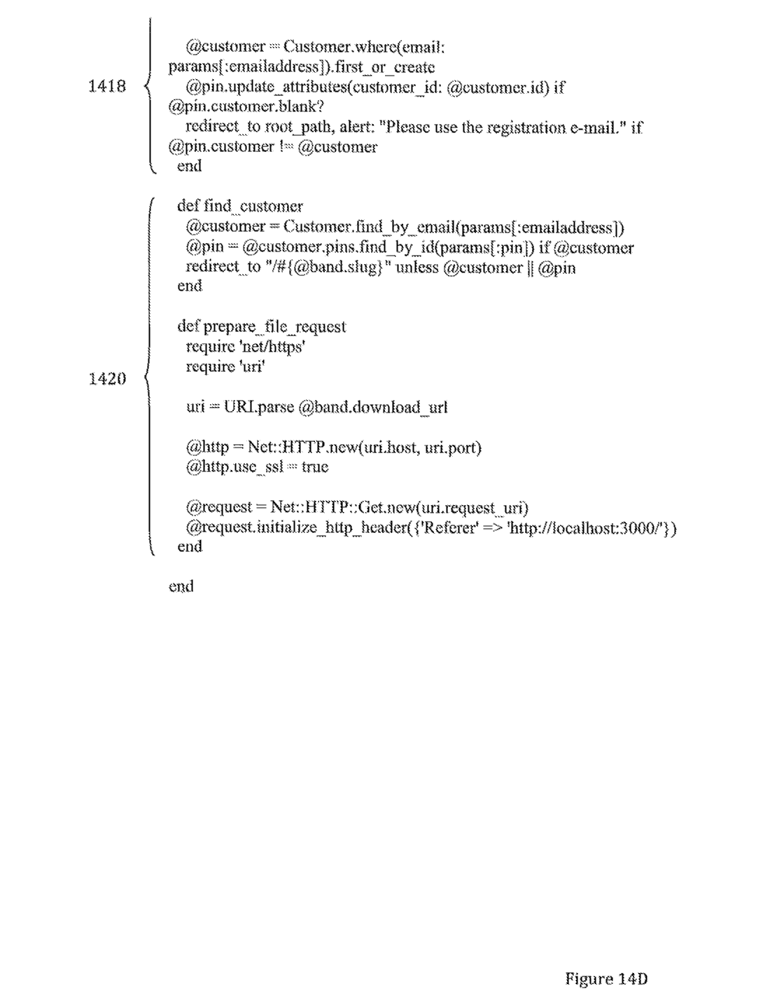

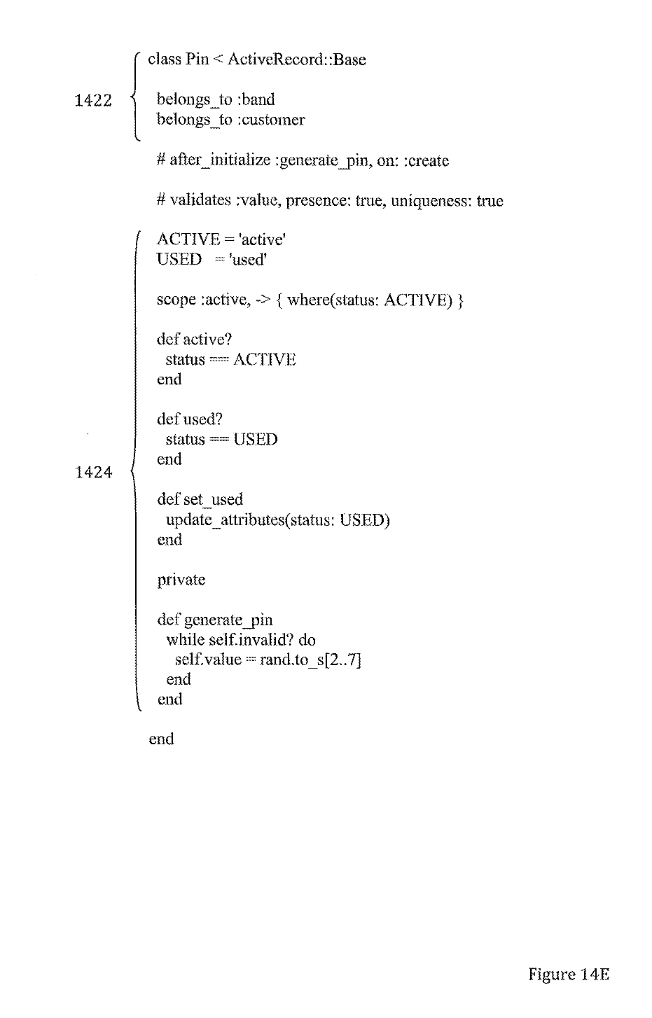

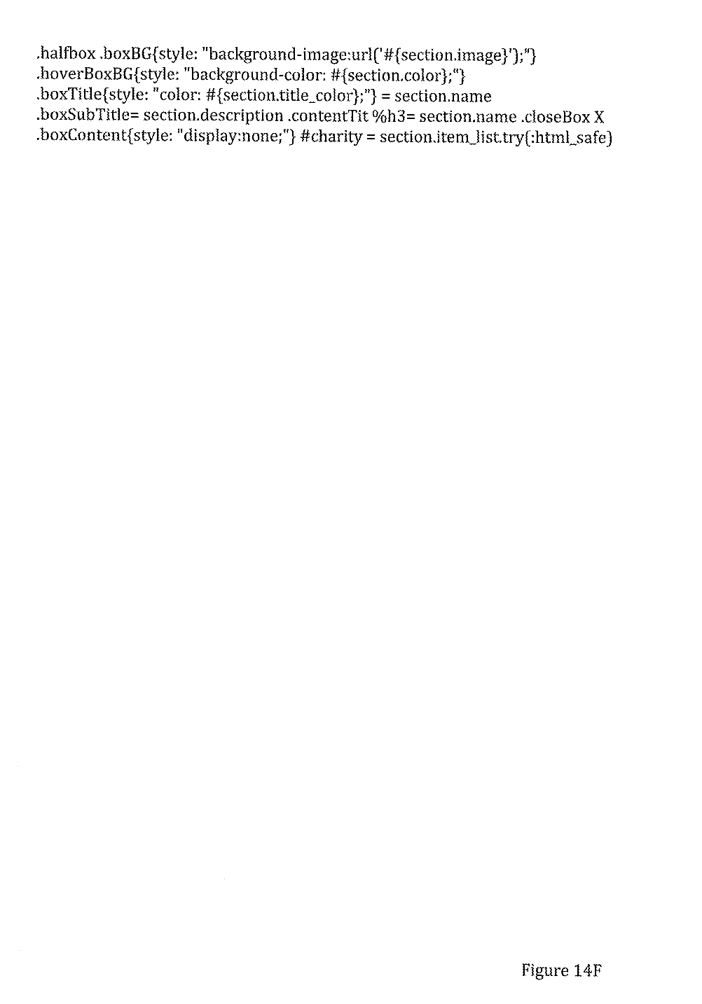

FIGS. 14A and 14B show the source code that creates the database structure for the software that runs the system. Section 1402 defines a “bands” table in the database. Section 1404 defines a “customers” table. An “images” table is created in section 1406 of the source code. Section 1408 defines a “pins” table in the database. Section 1410 defines a “section types” table. A “sections” table is created in section 1412.

FIGS. 14C and 14D show the source code which verifies a user's access to the related digital content. Section 1414 defines various fields and sets initial values for the fields. After a user clicks the link to initiate the download of the downloadable digital content, section 1416 checks for expiration of the PIN and sends an “expired” message to the user if PIN has expired. Section 1418 checks for the validity of the PIN and profile information combination. Section 1420 executes the download of the downloadable digital content to the user.

FIG. 14E is a representative selection of the source code which allows access to a landing page. The code verifies the digital key and the user submitted PIN and directs the user to the appropriate landing page depicting the artist/album related to the purchase of the physical product. Section 1422 recognizes the digital key destination. Section 1424 determines if the entered PIN is valid or expired.

FIG. 14F is an HTML template which drives the social media and charity web applications on the landing page.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A system for the secure delivery of digital content related to the purchase of a physical product comprising:
a server connected to a network and a database connected to the server;
a unique combination of a digital key and a PIN delivered with the physical product, the combination associated with the physical product and stored in the database;
a user device connected to the network and further capable of reading the digital key;
a first page generated by the server upon identification of the digital key by the server, the first page displayed by the user device for data entry; and,
a second page generated by the server upon verification of the combination by the server, the second page displayed by the user device for interaction with a set of digital content.

2. The system for the secure delivery of digital content related to the purchase of a physical product of claim 1 further comprising:
an active link generated by the server and transmitted over the network to the user device, the link displayed by the user device for access to a digital download.

3. The system for the secure delivery of digital content related to the purchase of a physical product of claim 2 where the link is generated by the server upon verification of the combination by the server.

4. The system for the secure delivery of digital content related to the purchase of a physical product of claim 2 where the link is generated by the server upon verification of the combination by the server such that the link expires after a predetermined duration after generation.

5. The system for the secure delivery of digital content related to the purchase of a physical product of claim 1 further comprising:
the second page including a web application generated by the server and displayed on the user device;
the web application capable of providing digital data from the set of digital content to the user device where the digital data is selected from the group consisting of a music file, an image file, and a video file.

6. The system for the secure delivery of digital content related to the purchase of a physical product of claim 1 further comprising:
the second page including a web application generated by the server and displayed on the user device; and,
the web application capable of providing digital data from the set of digital content to the user device where the digital data is selected from the group consisting of a social media link and a web page link featuring a set of merchandise related to the physical product.

7. The system for the secure delivery of digital content related to the purchase of a physical product of claim 1 where the first page is customized with a set of images related to the physical product.

8. The system for the secure delivery of digital content related to the purchase of a physical product of claim 1 where the second page is customized with a set of web applications related to the physical product.

9. The system for the secure delivery of digital content related to the purchase of as physical product of claim 1 further comprising:
a set of metrics collected by the server and stored in the database, the set of metrics related to the data entry and to the interaction with the set of digital content.

10. In a system comprising a server, the server connected to a network, and a database connected to the servo; a method for delivering secure digital content related to a physical product from the server to a user device connected to the network, the method comprising:
purchasing the physical product;
following a digital key via the user device to an opt-in page created by the server;
inputting a PIN via the user device to the opt-in page;
inputting user information via the user device to the opt-in page;
interacting with a landing page created by the server via the user device;
receiving an active link to the digital content via the user device;
accessing the active link via the user device; and,
delivering the digital content from the database to the use device over the network.

11. The method of claim 10 further comprising:
receiving a PIN with the purchase of the physical product.

12. The method of claim 10 were the step of following a digital key via the user device to an opt-in page created by the server is selected from the group consisting of entering a uniform resource locator (URL) address, scanning a quick response (QR) code, reading a near field communication (NFC) tag, and reading a radio frequency identification (RFID) tag.

13. The method of claim 10 further comprising:
revealing the PIN from under a scratch-off section included with the physical product.

14. The method of claim 10 where the step of inputting user information via the user device to the opt-in page is selected from the group consisting of supplying an email address, supplying a mobile phone number, logging in via a social media account.

15. The method of claim 10 where the step of interacting with a landing page created by the server via the user device is selected from the group consisting of streaming music stored on the database, viewing images stored on the database, viewing videos stored on the database, accessing a social media account, accessing a charity website, and accessing a website related to the physical product.

16. In a system comprising a server, the server connected to a network, a database connected to the server, and a user device connected to the network, a method for delivering secure digital content related to a physical product from the server to the user device, the method comprising:
purchasing the physical product;
accessing a digital key with the user device;
identifying the digital key on the server;
displaying an opt-in page related to the physical product on the user device;
entering a PIN and user information on the opt-in page via the user device;
verifying the PIN and digital key on the server;
displaying a landing page related to the physical product on the user device;
creating a link a digital download;
interacting with the landing page via the user device;
requesting the digital download via the user device;
verifying the validity of the digital download request on the server; and, delivering the digital download to the user device.

17. The method of claim 16 further comprising:
storing digital key and PIN combinations related to the physical product in the database.

18. The method of claim 16 further comprising:
storing purchase history related to the physical product in the database.

19. The method of claim 16 further comprising:
storing interactions with the landing page in the database; and,
creating a set of redeemable credits based on interactions activity.

20. The method of claim 16 were the step of interacting with the landing page via the user device is selected from the group consisting of streaming music stored on the database, viewing images stored on the database, viewing videos stored on the database, accessing a social media account, accessing a charity website, and accessing a website related to the physical product.
